(19) United States
(12) Patent Application Publication
(10) Pub. No.: US 2016/0054235 A1
(43) Pub. Date: Feb. 25, 2016

(54) SURFACE INSPECTION APPARATUS AND SURFACE INSPECTION METHOD

(71) Applicant: KOREA AEROSPACE RESEARCH INSTITUTE, Daejeon (KR)

(72) Inventors: Hyun Woo KIM, Suwon-si (KR); Jeong Hwan KO, Daejeon (KR); Eui Seung CHUNG, Daejeon (KR)

(21) Appl. No.: 14/552,188

(22) Filed: Nov. 24, 2014

(30) Foreign Application Priority Data
Aug. 20, 2014 (KR) 10-2014-0108153

(51) Int. Cl. G01N 21/94; G01N 21/88; G01N 21/95

(52) U.S. Cl. CPC G01N 21/94; G01N 21/95; G01N 21/8806; G01N 2021/8829; G01N 2201/061; G01N 2201/0638

(57) ABSTRACT

Provided are a surface inspection apparatus and a surface inspection method. More particularly, disclosed are a surface inspection apparatus and a surface inspection method to allow for inspection of a foreign material on non-uniformly colored diffusive surfaces containing a metal or polymer material or the like.

### BACKGROUND OF THE INVENTION

1. Field of the Invention

The present invention relates to a surface inspection apparatus and a surface inspection method, and more particularly to a surface inspection apparatus and a surface inspection method to allow for inspection of foreign materials on non-uniformly colored diffusive surfaces containing a metal or polymer material or the like.

2. Description of the Related Art

In general, high-precision components made of a metal or polymer material used in aerospace cause great problems due to surface contaminations by foreign materials.

To prevent these problems, in the prior art, dark-field and bright-field methods had been used as a method for optically inspecting such surfaces.

In accordance with the dark-field method, light is emitted by a light source to the surface of an object to be inspected and light scattered by foreign materials present on the surface is then measured with an optical sensor such as a camera.

In accordance with the bright field method, light is emitted by a light source to the surface of an object to be inspected in the same axis direction as in the passage in which a signal is measured with an optical sensor and the signal generated by a foreign material present on the surface is then measured.

However, the two conventional methods are applicable to an inspection of a foreign material on a reflective mirror surface such as glass or a semiconductor wafer and a diffusive surface with a uniform color such as white paper, but are disadvantageously inapplicable to an inspection of a foreign material on non-uniformly colored diffusive surfaces containing a metal or polymer material or the like.

### PRIOR ART

### Patent Document

Korean Patent No. 10-0416772 (Jan. 31, 2004)

### SUMMARY OF THE INVENTION

Therefore, the present invention has been made in view of the above problems, and it is an object of the present invention to provide a surface inspection apparatus and a surface inspection method which enable an inspection of foreign materials on non-uniformly colored diffusive surfaces containing a metal or polymer material or the like.

The object to be accomplished by the present invention is not limited to that described above and other objects not mentioned herein will be clearly understood to those skilled in the art from the description given below.

In accordance with the present invention, the above and other objects can be accomplished by the provision of a surface inspection apparatus for inspecting a surface of an object to detect a foreign material on the surface of the object, the surface inspection apparatus including a light emitter emitting light to the object, the light emitter including a light source, and a detector for detecting a shadow of the foreign material created on the surface of the object by the light emitted from the light source, the detector including an optical sensor, wherein the foreign material is detected based on an analysis of the shadow detected by the detector.

The light source may be inclined with respect to the surface of the object and an imaginary connection line extending from the light source in a direction of the emission of the light to the object forms an incident angle with the object.

The optical sensor may be disposed in an imaginary vertical line which is perpendicular to the surface of the object and extends upwardly from a point at which the imaginary connection line meets the object.

The detector may further include an imaging lens for imaging the shadow on the optical sensor.

The incident angle may be 30 degrees or less.

The surface inspection apparatus may further include a lens unit for converting the light emitted from the light source into parallel plane light, thereby transferring the parallel plane light to the object.

The surface inspection apparatus may further include a pinhole plate disposed between the light source and the lens unit, the pinhole plate having a pinhole configured for transmitting the light emitted from the light source, wherein the lens unit includes a convex lens disposed in front of the pinhole plate, the convex lens being configured for transmitting the emitted light having been transmitted through the pinhole.

The surface inspection apparatus may further include a regulation tube having two open ends, the regulation tube being movably coupled to the pinhole and configured for transmitting the light emitted from the light source.

The surface inspection apparatus may further include a base member having a front surface and a rear surface and both side surfaces, the base member being provided on an upper part thereof with a base plate on which the object is placed, and a support member for supporting the base member, the light emitter and the detector, wherein the support member includes a support frame including a left vertical bar and a right vertical bar, each of the left and right vertical bars having a lower part fixed to each of left and right side rails of the base plate respectively and configured to move forward and backward through the side rails, and a horizontal bar for connecting upper parts of the left and right vertical bars to each other, and a stationary bar fixed to a horizontal rail of the horizontal bar and configured to move leftward and rightward through the horizontal rail, the light emitter and the detector being fixed to the stationary bar

The support member may further include a front-and-back transfer device for transferring the support frame forward and backward, and a left-and-right transfer device for transferring the stationary bar leftward and rightward.

The support member may further include an up-and-down transfer device for transferring the horizontal bar upward and downward while connecting the horizontal bar to the vertical bars.

In accordance with another aspect of the present invention, provided is a surface inspection method for detecting a foreign material present on a surface of an object by the surface inspection apparatus, the method including preparing the object, emitting light to the surface of the object by a light emitter, detecting a shadow created on the surface of the object by the emitted light to the object, and detecting the foreign material according to the shadow detected by the detector.

The surface inspection method may further include analyzing the detected shadow so as to detect the foreign material.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a perspective view illustrating a surface inspection apparatus according to the present invention;

FIG. 2 is a conceptual view schematically illustrating the surface inspection apparatus according to the present invention;

FIG. 3 is a longitudinal sectional view illustrating a pinhole plate of the surface inspection apparatus according to the present invention; and

FIGS. 4 and 5 are a flowchart and a conceptual view illustrating a surface inspection method according to the present invention, respectively.

### DETAILED DESCRIPTION OF THE INVENTION

Hereinafter, exemplary embodiments of the present invention will be described in more detail with reference to the annexed drawings.

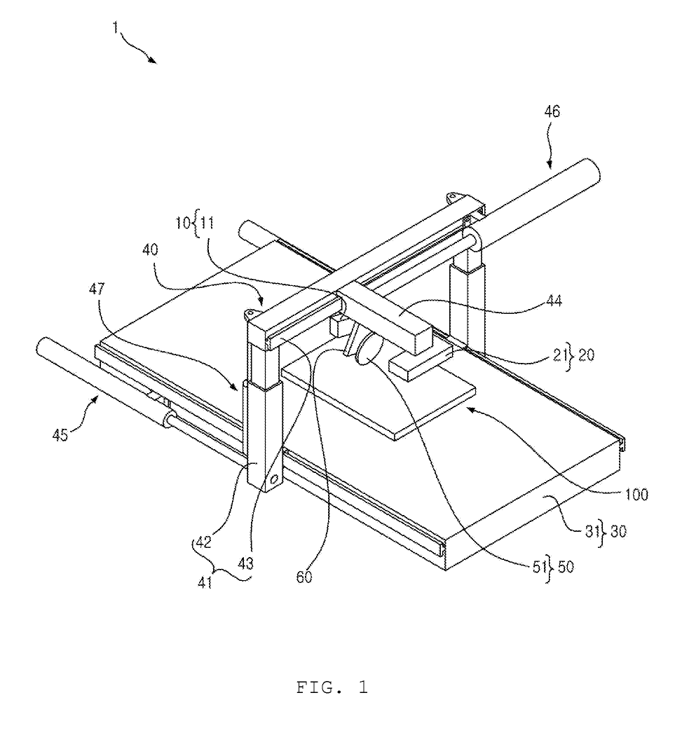

Referring to FIGS. 1 to 5, the present invention provides a surface inspection apparatus 1 for inspecting a surface of an object 100 to be inspected (hereinafter, simply referred to as an object) to detect a foreign material 200 thereon, wherein the surface inspection apparatus 1 includes a light emitter 10 for obliquely emitting light to the object 100, and a detector 20 disposed on the object 100 and detecting a shadow 210 generated by the light emitted to the object, wherein the foreign material 200 is detected, based on an analysis of the shadow 210 detected by the detector 20.

The object 100 contains a metal or polymer or the like having a non-uniformly colored diffusive surface.

As shown in FIG. 1, the surface inspection apparatus 1 may further include a base member 30 on which the object 100 is mounted or placed, and a support member 40 for supporting the base member 30, the light emitter 10 and the detector 20.

The base member 30, which has a front surface, a rear surface and two side surfaces, includes, in an upper part thereof, a base plate 31 on which the object 100 can be mounted or placed, and a transport means (not shown) for moving the object 100 mounted or placed on the base plate 31 in front, back, left and right directions.

The front, back, left and right directions are preferably understood to correspond to front and rear surface directions and both side surface directions of the base plate 31.

The transport means may be provided as a known general means, such as a conveyor belt, for moving the object 100 in front, back, left and right directions, and a detailed explanation thereof is thus omitted.

The support member 40 includes a support frame 41 including a pair of left and right vertical bars 42, each of the left and right vertical bars having a lower part fixed to each of left and right side rails attached to the base plate 31 and configured to move forward and backward through the sides rails of the base plate 31 and a horizontal bar 43 for connecting upper parts of the pair of vertical bars 42 to each other, and a stationary bar 44 fixed to a horizontal rail of the horizontal bar 43 and configured to move leftward and rightward on the horizontal rail of the horizontal bar 43, and the light emitter 10 and the detector 20 are fixed to the stationary bar 44.

The support member 40 further includes a front-and-back transfer device 45 for transferring the support frame 41 forward and backward and a left-and-right transfer device 46 for transferring the stationary bar 44 leftward and rightward. In addition, the support member 40 may further include an up-and-down transfer device 47 for transferring the horizontal bar 43 upward and downward while connecting the horizontal bar 43 to the vertical bars 42.

The front-and-back transfer device 45, the left-and-right transfer device 46 and the up-and-down transfer device 47 may have a cylindrical shape as shown in FIG. 1 or any of various well-known shapes.

The front-and-back transfer device 45, the left-and-right transfer device 46 and the up-and-down transfer device 47 are provided in such a way that the apparatus 1 can inspect the entire surface of the object 100 mounted on the base member 30.

For example, in one embodiment of a method for inspecting the surface of the object 100, the surface inspection apparatus 1 detects an inspection signal of the foreign material 200 with the detector 20 fixed together with the light emitter 10 while transferring the object 100 forward and backward.

In another embodiment, the surface inspection apparatus 1 detects an inspection signal of the foreign material 200 present on the surface of the fixed object 100 while transferring the detector 20 together with the light emitter 10 forward and backward.

In another embodiment, the surface inspection apparatus 1 detects an inspection signal of the foreign material 200 present on the surface of the object 100 while transferring the object 100 in a side direction and transferring the detector 20 together with the light emitter 10 in another side direction.

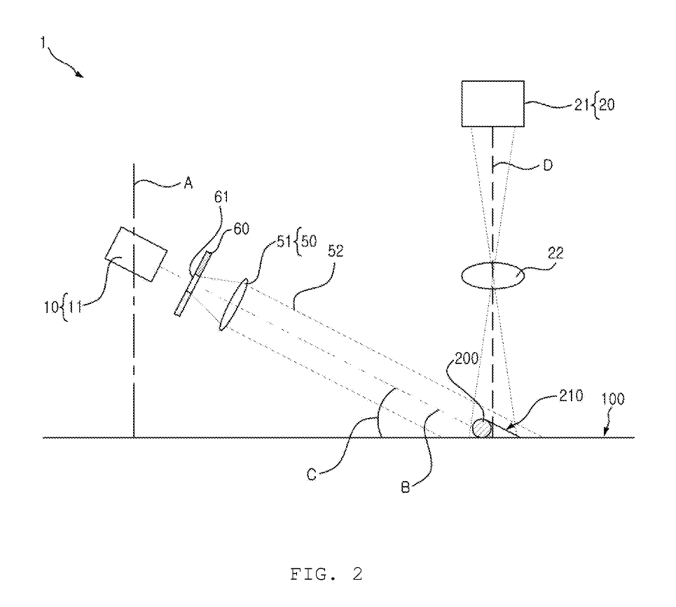

As shown in FIG. 2, the light emitter 10 includes a light source 11 such as a LED lamp, a metal halide lamp or a halogen lamp, and can be turned on or off upon receiving power from the outside.

The light source 11 is inclined toward a side based on an imaginary base line A vertical to the object 100, i.e., the light source 11 is inclined with respect to the surface of the object 100, and obliquely emits light to the object 100, as shown in FIG. 2.

That is, regarding the light source 11, an imaginary connection line B extending in the direction in which light is emitted to the object 100 forms an incident angle C with the object 100.

The imaginary connection line B is understood to correspond to a direction of the light emitted from the light source 11 and the incident angle C is most preferably 30 degrees or less.

The detector 20 includes an optical sensor 21 for detecting a shadow 210 of the foreign material 200 created on the object 100 by the emitted light from the light source 11 to the object 100, and the optical sensor 21 preferably includes a CCD camera or the like.

The detector 20 may further include an imaging lens 22 disposed under the optical sensor 21. The imaging lens 22 is configured to image a detection signal of the shadow 210 on the optical sensor 21. Further, the imaging lens 22 may be connected to the optical sensor 21 or the support member 40.

The optical sensor 21 can be disposed in the imaginary vertical line D which extends upwardly from the point at which the imaginary connection line B meets the object 100.

The surface inspection apparatus 1 may further include a lens unit 50 for converting the light emitted from the light source 11 into parallel plane light 52.

As shown in FIG. 2, the lens unit 50, which includes a convex lens 51, is disposed in front of the light source 11 to convert the light emitted from the light source 11 into the parallel plane light 52 and emits the parallel plane light 52 to the surface of the object 100.

Here, the parallel plane light 52 has both side edges of light transmitted through the lens unit 50 which are parallel to each other wherein a predetermined width is present between the edges.

The shadow 210 is created on the surface of the object 100 due to shading of light by the foreign material 200 when the parallel plane light 52 is emitted to the surface of the object 100. The detector 20 detects the shadow 210 created on the surface of the object 100.

The detector 20 detects, by the optical sensor 21, a strong signal, that is, a white signal, from a region where the foreign material 200 is not present and a region where the foreign material 200 is present, and detects a weak signal, that is, a black signal, from a region where the shadow 210 is present, due to the emission of light to the object 100.

The surface inspection apparatus 1 can detect the foreign material 200 based on the analysis of the detection signal of the shadow 210 detected by the detector 20.

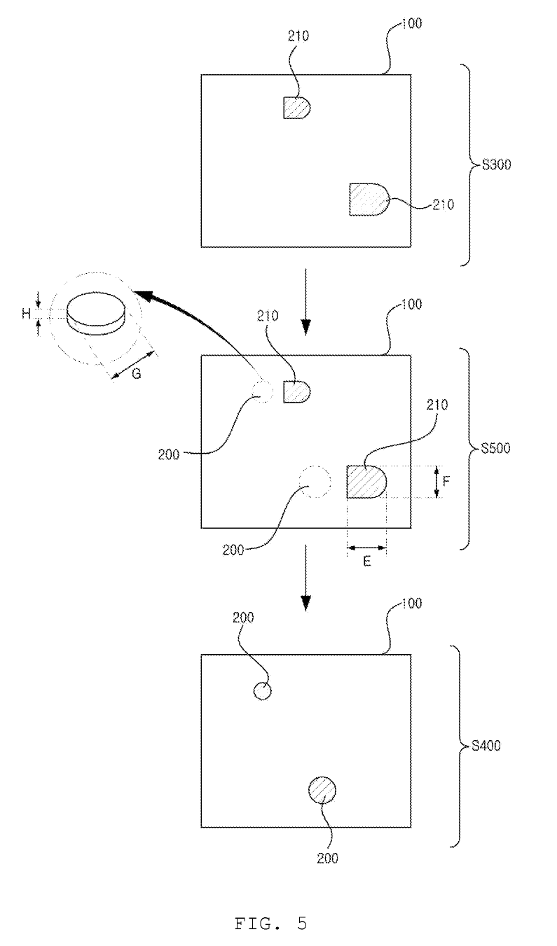

In addition, the size of the foreign material 200 can be measured from the size of the shadow 210. For example, as shown in FIG. 5, a diameter G of foreign material is the same as a length F of the shadow and a height H of the foreign material is calculated by multiplying a width E of the shadow by tan C (incident angle).

As shown in FIG. 2, the surface inspection apparatus 1 is disposed between the light emitter 10 and the lens unit 50 and further includes a pinhole plate 60 provided with a pinhole 61 transmitting the light emitted from the light emitter 10.

The pinhole plate 60 enables the light generated by the light source 11 to sequentially be transmitted through the pinhole 61 and the convex lens 51 before being transmitted through the convex lens 51.

The pinhole plate 60 may be fixed on the stationary bar 44 movably forward and backward between the light source 11 and the convex lens 51.

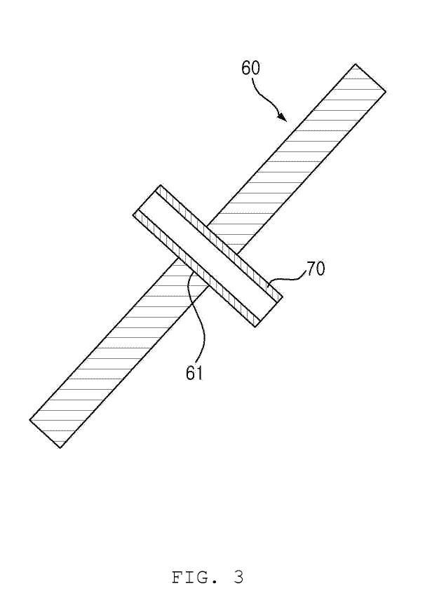

Alternatively, as shown in FIG. 3, the surface inspection apparatus 1 may further include a regulation tube 70 which has two open ends, being movably coupled to the pinhole 61 toward the both ends, and transmits the emitted light of the light source 11.

The regulation tube 70 efficiently converts the light generated by the light source 11 into the parallel plane light through the convex lens 51 upon a movement of the pinhole plate 60 and the regulation tube 70.

For this reason, the surface inspection apparatus 1 efficiently detects the foreign material 200 present on the surface of the object 100.

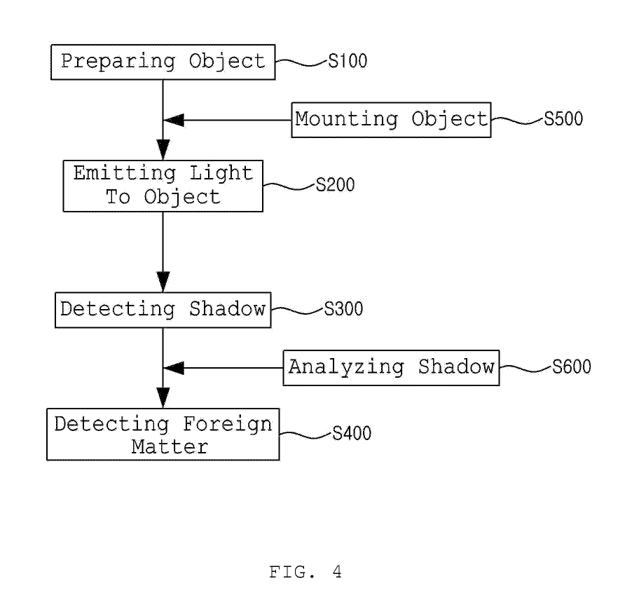

Meanwhile, a surface inspection method for inspecting the surface of the object 100 by the surface inspection apparatus 1 according to the present invention with reference to FIGS. 4 and to detect a foreign material 200 present thereon includes preparing the object 100 to be inspected (S100), emitting light to the surface of the object 100 by the light emitter 10 (S200), detecting the shadow 210 of the foreign material 200 created on the surface of the object 100 by the emitted light to the object 100 by the light emitter 10 (S300) and detecting the foreign material 200 according to the shadow 210 detected by the detector 20 (S400).

The surface inspection method may further include loading the object 100 prepared in the previous step(S100) on the base member 30 before emitting light to the surface of the object 100 (S200).

The emission of light to the object 100 (S200) includes emitting light to the surface of the object 100 by the light source 11 at a predetermined incident angle of 30 degrees or less.

The foreign material 200 present on the surface of the object 100 forms the shadow 210 on the surface of the object 100 by light shielding.

The shadow 210 can be created at the back of the foreign material 200 by the light emitted to the front of the foreign material 200 from the light source 11 and the detector 20 can detect the shadow 210 in the shadow detection step (S300).

That is, the optical sensor 21 detects a strong signal, that is, a white signal, from a region where the foreign material 200 is not present and a region where the foreign material 200 is present, and detects a weak signal, that is, a black signal, from a region where the shadow 200 is present, due to the emission of light to the object 100 (S200).

As a result, in the detection of the foreign material (S400), the foreign material can be detected according to the shadow detection signal obtained in the shadow detection step (S300).

The surface inspection method may further include analyzing the shadow 210 detected in steps (S300) and (S600) so as to detect the foreign material (S400).

In the shadow analysis step (S600), a distribution of shadow detection signals detected in the shadow detection step (S300) is analyzed.

The size of foreign material 200 or the like can be obtained according to the distribution analysis of the shadow detection signals.

Accordingly, with the surface inspection method according to the present invention, it is possible to perform surface an inspection on non-uniformly colored diffusive surfaces containing a metal or polymer material or the like and detect foreign materials based on the surface inspection.

The effects obtained by the present invention are not limited to those described above and other objects not mentioned herein will be clearly understood to those skilled in the art from the description given above.

Although the preferred embodiments of the surface inspection apparatus and the surface inspection method according to the present invention have been disclosed for illustrative purposes, those skilled in the art will appreciate that various modifications, additions and substitutions are possible, without departing from the scope and spirit of the invention as disclosed in the accompanying claims.

What is claimed is:

1. A surface inspection apparatus for inspecting a surface of an object to detect a foreign material on the surface of the object, the surface inspection apparatus comprising:
a light emitter for emitting light to the object, the light emitter including a light source; and
a detector for detecting a shadow on the surface of the object by light emitted from the light source, the detector
wherein the foreign material is detected based on an analysis of the shadow detected by the detector.

2. The surface inspection apparatus according to claim 1, wherein the light source is inclined with respect to the surface of the object and an imaginary connection line extending from the light source in a direction of the emitted light to the object forms an incident angle with the object.

3. The surface inspection apparatus according to claim 2, wherein the optical sensor is disposed in an imaginary vertical line which is perpendicular to the surface of the object and extends upwardly from a point at which the imaginary connection line meets the object.

4. The surface inspection apparatus according to claim 2, wherein the detector further comprises an imaging lens for imaging the shadow on the optical sensor.

5. The surface inspection apparatus according to claim 2, wherein the incident angle is 30 degrees or less.

6. The surface inspection apparatus according to claim 2, further comprising a lens unit for converting the emitted light into parallel plane light, thereby transferring the parallel plane light to the object.

7. The surface inspection apparatus according to claim 6, further comprising a pinhole plate disposed between the light source and the lens unit, the pinhole plate having a pinhole configured for transmitting the emitted light,
wherein the lens unit comprises a convex lens disposed in front of the pinhole plate, the convex lens configured for transmitting the emitted light that passed through the pinhole.

8. The surface inspection apparatus according to claim 7, further comprising a regulation tube having two open ends, the regulation tube being movably coupled to the pinhole and configured for transmitting the emitted light.

9. The surface inspection apparatus according to claim 1, further comprising:
a base member having a front surface and a rear surface and both side surfaces, the base member being provided on an upper part thereof with a base plate on which the object is placed; and
a support member for supporting the base member, the light emitter and the detector,
wherein the support member comprises:
a support frame including a left vertical bar and a right vertical bar, each of the left and right vertical bars having a lower part fixed to each of left and right side rails of the base plate respectively and configured to move forward and backward through the side rails, and a horizontal bar for connecting upper parts of the left and right vertical bars to each other; and
a stationary bar fixed to a horizontal rail of the horizontal bar and configured to move leftward and rightward through the horizontal rail, the light emitter and the detector being fixed to the stationary bar.

10. The surface inspection apparatus according to claim 9, wherein the support member further comprises:
a front-and-back transfer device for transferring the support frame forward and backward; and
a left-and-right transfer device for transferring the stationary bar leftward and rightward.

11. The surface inspection apparatus according to claim 10, wherein the support member further comprises an up-and-down transfer device configured to transfer the horizontal bar upward and downward and configured to connect the horizontal bar and the vertical bars.

12. A surface inspection method for detecting a foreign material present on a surface of an object by using the surface inspection apparatus according to claim 8, the method comprising:
preparing the object;
emitting light to the surface of the object by a light emitter;
detecting a shadow created on the surface of the object by the emitted light to the object; and
detecting the foreign material according to the shadow detected by the detector.

13. The surface inspection method according to claim 12, further comprising analyzing the detected shadow so as to detect the foreign material.
